(19) United States
(12) Patent Application Publication
(10) Pub. No.: US 2005/0189017 A1
(43) Pub. Date: Sep. 1, 2005

(54) Emergency shutdown valve diagnostics using a pressure transmitter

(76) Inventor: Evren Eryurek, Edina, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 11/051,457

(22) Filed: Feb. 4, 2005

Related U.S. Application Data
(60) Provisional application No. 60/541,987, filed on Feb. 5, 2004.

(51) Int. Cl. G05D 7/06

(52) U.S. Cl. 137/487.5

(57) ABSTRACT

An emergency shut down valve is operated using a pressurized fluid. A pressure transmitter is operably coupleable to the source of pressurized fluid and is configured to receive an indication relative to emergency shut down valve diagnostics. The pressure transmitter responsively captures pressure readings relative to the source of pressurized fluid for a selected duration. In some embodiments, the pressure transmitter may perform diagnostics upon the captured data. In other embodiments, the captured data is provided to an external device for analysis.

### CROSS REFERENCE TO RELATED APPLICATION

The present application is based on and claims the benefit of U.S. provisional patent application Ser. No. 60/541,987, filed Feb. 5, 2004, the content of which is hereby incorporated by reference in its entirety.

### BACKGROUND OF THE INVENTION

The present invention relates to diagnostics of emergency shutdown valves.

Emergency shutdown valves are designed to take a process, such as an industrial process like oil refining, to a safe state if certain pre-specified operating limits are exceeded. Emergency shutdown valves may take any of a variety of forms, for example, gate valves, butterfly valves, rotary or ball valves. An emergency valve is generally operated using a source of pressurized fluid. One method of operation involves an actuator using hydraulic or gas pressure to retain the valve in its normal, for example, open, position. When the emergency valve is to be shut, the hydraulic or gas pressure is released and a metal spring or other mechanism closes the valve. In the case of a double acting actuator, the medium controlling the actuator is redirected to close the valve. The application of the hydraulic or gas pressure is normally controlled by one or more electrically controlled solenoid valves. An electrical signal is provided to the solenoid valve(s) by an electrical control line. Any interruption of the electrical signal will operate the solenoid valves to release or divert the hydraulic or gas pressure and hence closes the valve.

One of the difficulties with maintaining such emergency valves is due to the nature of the process itself. For example, a process such as oil refining is generally in continuous operation and the cost of shutting any particular line down to perform maintenance work can be very high. As a consequence emergency valves are generally not moved or otherwise operated between maintenance intervals, which may sometimes be several years. Over that time, dirt or other material may become deposited in the valve, which may become stuck and potentially inoperable in the event of an emergency.

Accordingly, it is highly desirable, and in some cases required, to test emergency shutdown (ESD) valves at relatively frequent intervals to ensure that they are operable. This helps ensure the overall reliability and safety of an industrial process. When such diagnostics are performed, the system may be shut down completely, and a full-stroke test or diagnostics performed. Recent developments have allowed for diagnostics of such emergency shutdown valves to be performed without shutting down the entire process to which they are connected. These diagnostics are typically performed by partially stroking the emergency shutdown valve, and accordingly not shutting down the process.

Regardless of whether the diagnostics partially stroke the ESD valve, or fully stroke it, fluid pressure provided to the emergency shutdown valve is monitored over time. A number of data points are obtained relative to the fluid pressure in the seconds following actuator or solenoid energization. The shape of the plot of pressure versus time, also referred to herein as a pressure signature, for this set of data is known to reveal a number of diagnostic conditions relative to emergency shutdown valves. Examples of ESD valve system diagnostics that can be computed, or otherwise derived, from pressure signatures include: stem shear; solenoid failure, a sticking solenoid, a restricted exhaust port, and the valve or actuator being stuck. In fact, it has been suggested that a surprising amount of ESD valve diagnostic information can be obtained merely by adding a pressure transmitter in the exhaust line of the actuator and capturing the signal profile or signature of the valve during closure with a microcomputer.

One drawback of current diagnostic systems that employ a pressure transmitter providing pressure readings over time to a microcomputer is that the data obtained and stored at the microcomputer has relatively poor temporal resolution relative to the event (typically occurring in a few seconds). Thus, it would significantly improve the process of diagnosing or otherwise maintaining emergency shutdown valves if the temporal resolution could be significantly increased without unduly impacting costs, or requiring significant technician time.

### SUMMARY OF THE INVENTION

An emergency shut down valve is operated using a pressurized fluid. A pressure transmitter is operably coupleable to the source of pressurized fluid and is configured to receive an indication relative to emergency shut down valve diagnostics. The pressure transmitter responsively captures pressure readings relative to the source of pressurized fluid for a selected duration. In some embodiments, the pressure transmitter may perform diagnostics upon the captured data. In other embodiments, the captured data is provided to an external device for analysis.

### BRIEF DESCRIPTION OF THE DRAWINGS

FIG. 1 is a diagrammatic view of a pressure transmitter coupled to an emergency shutdown valve.

FIG. 2 is a diagrammatic view of a pressure transmitter providing ESD diagnostics in accordance with an embodiment of the present invention.

FIG. 3 is a flow diagram of a method of capturing ESD valve diagnostic data using a pressure transmitter in accordance with an embodiment of the present invention.

FIG. 4 is a diagrammatic view of a three-dimensional chart illustrating wavelet analysis in accordance with an embodiment of the present invention.

FIG. 5 shows a pressure signature contrasted of an ESD valve system having a stem shear problem contrasted with a known “good” signature.

### DETAILED DESCRIPTION OF THE PREFERRED EMBODIMENTS

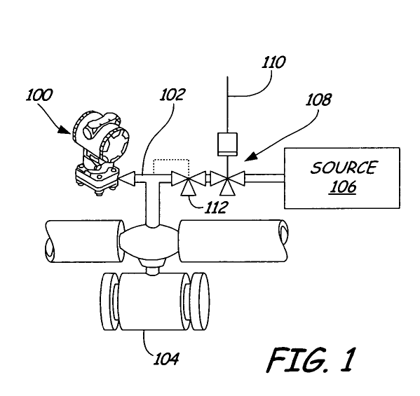

FIG. 1 is a diagrammatic view of a pressure transmitter coupled to an emergency shutdown valve. Pressure transmitter 100 is fluidically coupled to pressurized gas within line 102, which pressurized gas controls the operation of emergency shutdown valve 104. The pressurized gas is provided by source 106. Solenoid valve 108 is illustrated as being interposed between emergency shutdown valve 104 and source 106. Solenoid valve 108 is energized by control line 110 when actuation of valve 104 is desired. In order to reduce the reaction time of valve 104, one or more quick exhaust valves 112 may be provided as is known in the art.

In the past, pressure readings from transmitter 100 were conveyed to a microcomputer (not shown), which stored a number of such readings over time. Then, the microcomputer could construct a chart plotting pressure measured by transmitter 100 over time. As mentioned briefly above, this approach suffers from a significant drawback. Specifically, the resolution available to the microcomputer is limited by the rate at which the pressure transmitter can obtain pressure measurements and/or communicate them to the microcomputer. While current industry standard communication protocols and process instruments may support updating many times per second, this rate may not be sufficient to capture, or otherwise convey, extremely fleeting aspects of the pressure/time diagnostics of the emergency shutdown (ESD) valve. In accordance with one embodiment of the present invention, digital data corresponding to pressure measurements is obtained at a rate faster than can be communicated by the pressure transmitter. Essentially, when so instructed, the pressure transmitter itself becomes a capture device. This allows the pressure transmitter to focus solely upon obtaining and storing as many digital representations of the pressure as possible and potentially freeing the controller of the transmitter from other tasks, such as communications.

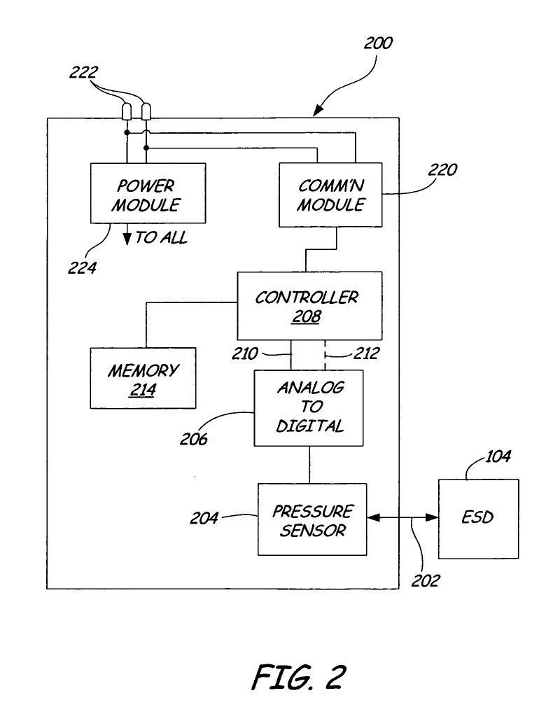

FIG. 2 is diagrammatic view of pressure transmitter 200 coupled to and providing diagnostics relative to ESD valve 104. As illustrated at line 202, pressure sensor 204 of pressure transmitter 200 is fluidically coupled, in any suitable manner, to emergency shutdown valve 104. This may be accomplished merely by tapping into the pressure line feeding ESD valve 104. Alternatively, pressure transmitter 200 may simply be disposed in the exhaust line of the actuator. Pressure sensor 204 can be any suitable structure that has an electrical characteristic that varies with an applied pressure. For example, pressure sensor 204 can be a known capacitance-type diaphragm pressure sensor. Preferably, however, sensor 204 is a semiconductor-based pressure sensor. These types of pressure sensors are taught in U.S. Pat. No. 5,637,802, assigned to the Assignee of the present invention. Such semiconductor-based pressure sensors generally provide a capacitance that varies with deflection of a portion of the semiconductor sensor. The deflection is in response to an applied pressure.

The use of semiconductors, and in particular, sapphire provides a number of advantages. Sapphire is an example of a single-crystal material that when properly fusion-bonded has no material interface between the two bonded portions. Thus, the resulting structure is exceptionally robust. Additionally, semiconductor-based sensors have extremely beneficial hysteresis characteristics as well as an extremely high frequency response. Additional information related to semiconductor-based pressure sensors can be found in U.S. Pat. Nos. 6,079,276; 6,082,199; 6,089,907; 6,484,585; and 6,520,020, all of which are assigned to the Assignee of the present invention. Accordingly, even extremely fleeting pressure events occurring during the ESD diagnostics will be electrically measurable using such a pressure sensor.

Analog-to-digital converter 206 is coupled to pressure sensor 204 and provides a digital indication to controller 208 based upon the electrical characteristic of pressure sensor 204. In one embodiment, analog-to-digital converter 206 can be based on sigma-delta converter technology. Each converted digital representation of the pressure is provided to controller 208. Sigma-delta converters are often used in the process measurement and control industry due to their fast conversion times and high accuracy. Sigma-delta converters generally employ an internal capacitor charge pumping scheme that generates a digital bitstream that is analyzed, generally by counting positive 1's over a set interval. The digital values converted by converter 206 are preferably provided to controller 208 along line 210.

In accordance with another embodiment of the present invention, converter 206 can provide the raw digital bitstream to controller 208 along line 212 (illustrated in phantom). This bitstream usually has a frequency that is many orders of magnitude higher than the conversion frequency of converter 206. For example, a sigma-delta converter may provide a digital bitstream that has a frequency of approximately 57 kHz. Accordingly, when transmitter 200 needs to perform a high-speed capture, it can do so in one of two ways. First, it may simply use controller 208 to store digital values provided on line 210 at the conversion rate of converter 206, which values are then stored in memory 214 for later analysis. Accordingly, the rate at which these values are acquired and stored is dictated solely by the conversion rate of converter 206. In distinct contrast, in the past, a microcomputer communicating with a pressure transmitter would be limited by the rate at which the two devices could communicate as well as the conversion rate of an analog-to-digital converter in the pressure transmitter.

For maximum resolution, pressure transmitter 200 can employ converter 206 to store the raw bitstream from line 212 directly into memory 214. Thus, a sigma-delta converter providing a digital bitstream having a frequency of approximately 57 kHz will provide 57,000 bits to be stored in memory 214 for each second that the capture occurs. In many ESD diagnostics, such as those listed above, the tests can be completed in approximately 8 seconds or less. Thus, it is preferred that memory 214 have at least 64 kilobytes of capacity available for capture data. However, in embodiments where the pressure transmitter will store one or more pressure-time valve profiles, such as a profile of a known “good” valve, additional capacity would be required.

Controller 208 is preferably a microprocessor that is adapted to operate on relatively low power levels, such as those commonly present in field devices such as pressure transmitters. Controller 208 is coupled to communication module 220, which is operably coupled to loop terminals 222. Communication module 200 allows transmitter 200 to communicate upon a process communication loop in accordance with a process industry standard protocol such as, but not limited to, FOUNDATION™ Fieldbus, HART®, Profibus-PA, Modbus, Controller Area Network (CAN), or others. Power module 224 is also preferably coupled to loop terminals 222 and is adapted to provide operating power to other elements within pressure transmitter 200 from electrical energy received through terminals 222. For example, some industry standard communication protocols such as HART® and FOUNDATION™ Fieldbus are able to provide operating power over the same wires through which communication is effected.

While transmitter 200 is described with respect to a power module 224 and communication module 220 coupled to a process communication loop through terminals 222, embodiments of the present invention may also be practiced with a pressure transmitter that is not coupled to any other devices through wires. For example, power module 224 could, instead, be an internal power source such as a storage cell or it could be an energy converter such as a solar cell, or any combination thereof. Additionally, communication module 220 could be a wireless communication module employing wireless communication, such as radio frequency or infrared communication techniques.

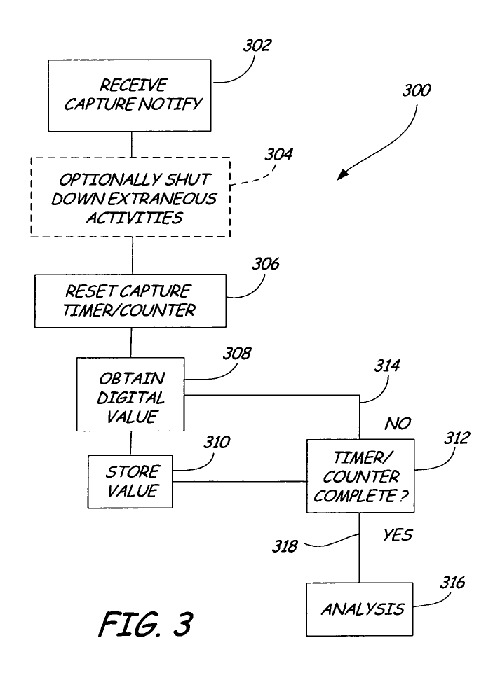

FIG. 3 is a flow diagram of a method of capturing ESD valve diagnostic data using a pressure transmitter in accordance with an embodiment of the present invention. Method 300 begins when a pressure transmitter, such as transmitter 200, receives a notification that capture is to begin, as illustrated at block 302. The notification can be transmitted to the pressure transmitter over a process industry communication loop, or provided to the pressure transmitter locally by a technician. Once the transmitter receives the notification that capture is to begin, block 304, illustrated in phantom, is optionally performed. Block 304 is used to shut down any pre-selected processes or activities within the pressure transmitter that are not directly related to or necessary for data capture. Thus, if controller 208 typically devotes a percentage of its processing time to listening to communications on the process communication loop, that activity can be ceased, and the availability of controller 208 to facilitate high speed data capture can be increased. Once optional block 304 has been completed, controller 208 will reset or otherwise initialize a timer or counter that will be used to measure the duration of the capture event. For example, as described above, many ESD diagnostics can be completed by obtaining approximately 8 seconds of captured data. In such cases, the timer within controller 208 will be set to 0 seconds at the beginning of capture and ultimately, after 8 seconds have elapsed, the capture event will cease.

Once the timer or counter is initialized, control passes to block 308 where controller 208 obtains a digital value from analog-to-digital converter 206. The digital value can be a finished analog-to-digital conversion or a single bit in the bitstream. At block 310, the digital value obtained by controller 208 from analog-to-digital converter 206 is stored, preferably in memory 214. Once the value is stored, control passes to block 312 where the timer or counter initialized in block 306 is evaluated to determine if the capture duration has elapsed. If not, control returns to block 308 along line 314 and the process of obtaining and storing digital values repeats. However, if the capture is complete, control passes to block 316 along line 318. At block 316, an analysis of the pressure data captured over time is accomplished. This analysis can be done by either the pressure transmitter itself or by an external device. If the analysis is to be performed by an external device, the captured block of data is preferably communicated to the external device using communications module 220.

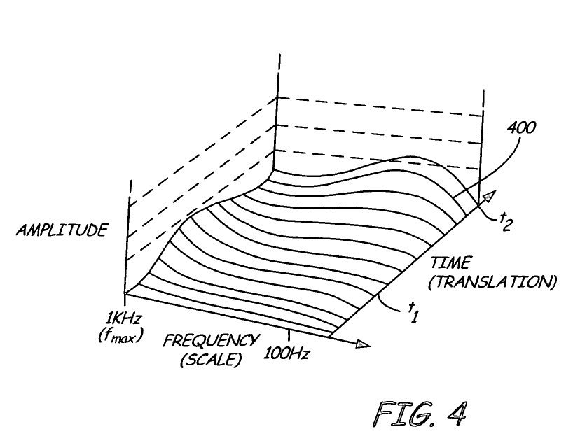

One important tool that is useful in the analysis of the captured data is a technique known as wavelet analysis. Wavelet analysis is used for transforming a time-domain signal into the frequency domain, which, like a Fourier transformation, allows the frequency components to be identified. However, unlike a Fourier transformation, in a wavelet transformation the output includes information related to time. This may be expressed in the form of a three-dimensional graph (400 in FIG. 4) with time shown on one axis, frequency on a second axis and signal amplitude on a third axis. A discussion of wavelet analysis is given in On-Line Tool Condition Monitoring System With Wavelet Fuzzy Neural Network, by L. Xiaoli et al., Eight JOURNAL OF INTELLIGENT MANUFACTURING, pgs. 271-276 (1997). In performing a continuous wavelet transformation, a portion of the sensor signal is windowed and convolved with a wavelet function. This convolution is performed by superimposing the wavelet function at the beginning of a sample, multiplying the wavelet function with the signal and then integrating the results over the sample period. The result of the integration is scaled and provides the first value for continuous wavelet transform at time=0. This point may then be mapped onto a three-dimensional plane. The wavelet function is then shifted right (forward in time) and the multiplication and integration steps are repeated to obtain another set of data points, which are mapped onto the three-dimensional space. This process is repeated and the wavelet is moved (convolved) through the entire signal. The wavelet function is then scaled, which changes the frequency resolution of the transformation, and the above steps are repeated.

Other types of signal analysis tools can also be used in accordance with embodiments of the present invention. Such techniques include, but are not limited to, learning techniques, neural networks, and fuzzy logic. Additionally the signal analysis techniques taught in U.S. Pat. No. 6,397,114 may also be used to provide ESD valve system diagnostics in accordance with embodiments of the present invention. Further, any analysis that allows one signal to be effectively contrasted to another signal can be employed. Thus, embodiments of the present invention even include providing the captured signature to a human operator for review.

Once the ESD pressure signature is captured by the pressure transmitter, it is preferably analyzed by comparing the signature to known pressure signature profiles of specific ESD valve system problems. Examples of such problems/signatures include stem shear, solenoid failure, a sticking solenoid, a restricted exhaust port, as well as a valve or actuator sticking. These comparative diagnostics can be performed by either the pressure transmitter or an external device.

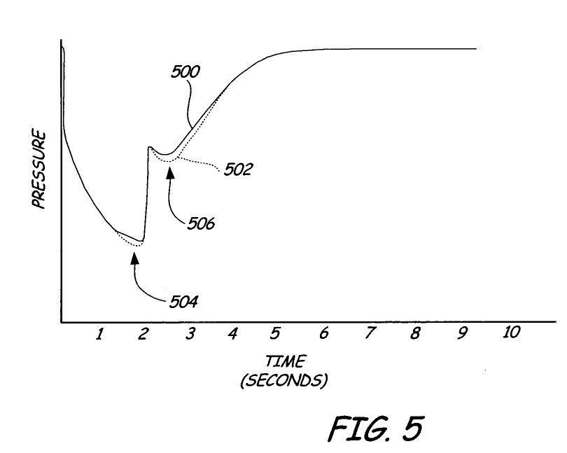

In embodiments where the comparison is performed by the pressure transmitter, any of analytical techniques listed above can be used. FIG. 5 shows a pair of pressure signatures. The solid line 500 is a signature indicative of known “good” ESD valve system operation. The known “good” signature can be obtained by the transmitter itself by providing it with an indication that it is coupled to a fully operation system, and allowing it to capture a signature. Alternatively, the “good” signature could be sent to the transmitter via the communications module. Dashed line 502 is follows a path that is identical to line 500 except for regions 504 and 506. In these regions the ESD system under test drops to a slightly lower pressure than the known “good” signature. This particular behavior is indicative of valve shear in the ESD valve system. Any number of techniques could be used to identify this pattern. However, simple recording the magnitude of local minima of a ESD valve system and comparing those values with local minima for a known “good” system would indicate the valve shear problem. Regardless of the techniques used, it is preferred that the results of the comparison be communicated by the pressure transmitter. Thus, if the pressure transmitter determines that the signature obtained during the capture resembles a known failure signature (either stored within the transmitter or sent to it), within a selected or arbitrary window, an indication of that error is provided by the pressure transmitter.

Although the present invention has been described with reference to preferred embodiments, workers skilled in the art will recognize that changes may be made in form and detail without departing from the spirit and scope of the invention.

1. A method in an industrial process of diagnosing an emergency shutdown valve actuated by a source of pressurized fluid, the method comprising:
controlling the source of pressurized fluid;
measuring a plurality of pressures related to the pressurized fluid;
storing the plurality of measurements in a pressure transmitter; and
comparing the pressure measurements with at least one known pressure signature to generate diagnostic information relative to the emergency shutdown valve.

2. The method of claim 1, wherein the pressure transmitter stores pressure measurements for a selected duration.

3. The method of claim 1, and further comprising providing a diagnostic initiation indication to the pressure transmitter.

4. The method of claim 3, wherein providing the diagnostic initiation indication includes transmitting a signal to the pressure transmitter over a process communication loop.

5. The method of claim 1, and further comprising ceasing at least one activity, unrelated to pressure measurement, of a controller of the pressure transmitter after receiving the indication.

6. The method of claim 1, wherein the comparing the pressure measurements with at least one known pressure signature includes performing wavelet analysis.

7. The method of claim 1, wherein comparing the pressure measurements with at least one known pressure signature is performed by the pressure transmitter.

8. The method of claim 1, wherein comparing the pressure measurements with at least one known pressure signature is performed by an external device in communication with the pressure transmitter.

9. The method of claim 1, wherein the diagnostic information indicates stem shear.

10. The method of claim 1, wherein the diagnostic information indicates solenoid failure.

11. The method of claim 1, wherein the diagnostic information indicates a sticking solenoid.

12. The method of claim 1, wherein the diagnostic information indicates a restricted exhaust port.

13. The method of claim 1, wherein the diagnostic information indicates the valve being stuck.

14. The method of claim 1, wherein the diagnostic information indicates a stuck actuator.

15. A pressure transmitter comprising:
a pressure sensor coupleable to a source of pressurized fluid operably coupled to an emergency shut down valve;
an analog-to-digital converter coupled to the pressure sensor and providing a digital output; and
a controller operably coupled to the analog-to-digital converter, the controller adapted to receive an indication relative to a diagnostic of the emergency shutdown valve and wherein the controller is adapted to store a plurality of digital values from the analog-to-digital converter digital output after receipt of the diagnostic indication.

16. The pressure transmitter of claim 15, wherein the analog-to-digital converter is a sigma-delta converter.

17. The pressure transmitter of claim 16, wherein the analog-to-digital converter provides a digital bitstream to the controller.

18. The pressure transmitter of claim 17, wherein the digital values are individual bits.

19. The pressure transmitter of claim 15, and further comprising a communication module coupled to the controller and being configured to communicate with an external device.

20. The pressure transmitter of claim 19, wherein the controller is adapted to perform an analysis upon the stored plurality of digital values to generate diagnostic information relative to the emergency shutdown valve.

21. The pressure transmitter of claim 19, wherein the communication module is adapted to transmit the stored plurality of digital values to another device for analysis.

22. The pressure transmitter of claim 15, wherein the pressure sensor is a capacitive pressure sensor.

23. The pressure transmitter of claim 22, wherein the pressure sensor is a semiconductor based pressure sensor.

24. The pressure transmitter of claim 15, and further comprising memory coupled to the controller to store the plurality of digital values.

25. The pressure transmitter of claim 24, wherein the memory has a capacity of at least 64 kilobytes.

26. The pressure transmitter of claim 15, wherein the controller is configured to compute ESD valve system diagnostic information using the plurality of stored values.

27. The pressure transmitter of claim 26, wherein the diagnostic information indicates stem shear.

28. The pressure transmitter of claim 26, wherein the diagnostic information indicates solenoid failure.

29. The pressure transmitter of claim 26, wherein the diagnostic information indicates a sticking solenoid.

30. The pressure transmitter of claim 26, wherein the diagnostic information indicates a restricted exhaust port.

31. The pressure transmitter of claim 26, wherein the diagnostic information indicates the valve being stuck.

32. The pressure transmitter of claim 26, wherein the diagnostic information indicates a stuck actuator.

33. An emergency shutdown valve system comprising:
a source of pressurized fluid;
a valve coupled to the source of pressurized fluid and having a valve output that is selectable based upon an energization signal; and
an emergency shutdown valve operably coupled to the valve output; and
means for diagnosing operation of the emergency shutdown valve.

34. A method of diagnosing operation of an ESD valve system driven by an applied fluid pressure, the method comprising:
measuring the applied pressure with a pressure transmitter; and
responsively diagnosing operation of the ESD valve system with the pressure transmitter
